(19) United States
(12) Patent Application Publication
(10) Pub. No.: US 2016/0124116 A1
(43) Pub. Date: May 5, 2016

(54) GENERATION OF STRUCTURAL ELEMENTS FOR SUBSURFACE FORMATION USING STRATIGRAPHIC IMPLICIT FUNCTION

(71) Applicant: Schlumberger Technology Corporation, Sugar Land, TX (US)

(72) Inventors: Laurent Arnaud Souche, Kuala Lumpur (MY); Patxi Lahetjuzan, Grabels (FR)

(21) Appl. No.: 14/924,678

(22) Filed: Oct. 27, 2015

(30) Foreign Application Priority Data
Oct. 29, 2014 (FR) 1460370

(51) Int. Cl. G01V 99/00

(52) U.S. Cl. CPC G01V 99/005

(57) ABSTRACT

A method, apparatus, and program product may utilize a stratigraphic implicit function, e.g., as used in connection with volume based modeling, to generate structural information for a subsurface formation. In particular, structural information for a subsurface formation may be generated by determining a location in a volume of interest in the subsurface formation from subsurface formation data associated with the subsurface formation, accessing a numerical model having a monotonously varying stratigraphic implicit function defined within the volume of interest to determine a value of the stratigraphic implicit function corresponding to the determined location, and generating at least one structural element for the subsurface formation from the stratigraphic implicit function of the numerical model based upon a spatial distribution of the determined value within the volume of interest.

### CROSS-REFERENCE TO RELATED APPLICATIONS

This application claims priority to French Patent Application Serial No. 1460370, filed on Oct. 29, 2014. The entirety of the priority patent application is incorporated by reference herein.

### BACKGROUND

Reservoir modeling and simulation are commonly used in the oil & gas industry to model the structure and/or properties of a subsurface formation, e.g., of the type containing recoverable hydrocarbons. Reservoir modeling and simulation may be used during various phases of exploration and production, including, for example, to attempt to predict the location, quantity and/or value of recoverable hydrocarbons, to plan the development of wells for cost-effectively extracting hydrocarbons from the subsurface formation, and to guide future and/or ongoing production and development decisions.

Reservoir modeling and simulation may be challenging due to the fact that data gathering techniques such as seismic surveys and well logging may provide an incomplete picture of the structure and other properties of a subsurface formation, particularly when a subsurface formation is highly faulted and/or otherwise of a complex structure. As a result, despite the increasing sophistication of computer modeling techniques, manual interpretation of collected data by skilled personnel is still relied upon in many circumstances to generate structural information representing the structure of the geological layers running through a subsurface formation. For example, determining the locations of geological layers within a subsurface formation generally involves manual interpretation of seismic survey data and/or well log data to identify common patterns in the data at different locations in the subsurface formation that indicate where a given geological layer is distributed throughout the subsurface formation. In some computer models, geological layers are represented by the surfaces between adjoining geological layers, which are generally referred to as horizons.

Well correlation, for example, is a process whereby well logs collected along the lengths of multiple boreholes are analyzed to attempt to identify where each borehole intersects the same horizon. The intersection of a borehole with a horizon is commonly referred to as a well top, and when well tops corresponding to the same horizon are found in multiple boreholes, the location and the trajectory of a geological layer throughout a subsurface formation may be better represented in a computer model, e.g., by refining the location of the geological layer as predicted from a seismic survey to conform to the locations of the well tops.

It has been found, however, that well correlation can be difficult and time consuming, particularly where a subsurface formation is highly faulted and/or when wells undertake complex well paths. In some instances, three dimensional reservoir grids may be repeatedly rebuilt as additional analysis is performed and additional information is added by a user, leading to lengthy delays in the overall process of building or refining a computer model of the subsurface formation.

Therefore, a need continues to exist in the art for an improved manner of generating structural information for a subsurface formation, e.g., in order to build or refine a computer model of a subsurface formation.

### SUMMARY

The embodiments disclosed herein provide a method, apparatus, and program product that utilize a stratigraphic implicit function, e.g., as used in connection with volume based modeling, to generate structural information for a subsurface formation.

In particular, embodiments consistent with the invention may generate structural information for a subsurface formation by determining a location in a volume of interest in the subsurface formation from subsurface formation data associated with the subsurface formation, accessing a numerical model having a monotonously varying stratigraphic implicit function defined within the volume of interest to determine a value of the stratigraphic implicit function corresponding to the determined location, and generating at least one structural element for the subsurface formation from the stratigraphic implicit function of the numerical model based upon a spatial distribution of the determined value within the volume of interest.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a block diagram of an example hardware and software environment for a data processing system in accordance with implementation of various technologies and techniques described herein.

FIGS. 2A-2D illustrate simplified, schematic views of an oilfield having subterranean formations containing reservoirs therein in accordance with implementations of various technologies and techniques described herein.

FIG. 3 illustrates a schematic view, partially in cross section of an oilfield having a plurality of data acquisition tools positioned at various locations along the oilfield for collecting data from the subterranean formations in accordance with implementations of various technologies and techniques described herein.

FIG. 4 illustrates a production system for performing one or more oilfield operations in accordance with implementations of various technologies and techniques described herein.

FIG. 5 illustrates components of an example volume based modeling structural framework, including input faults and horizon interpretations, a tetrahedral mesh, and relative stratigraphic age represented with a periodic color map.

FIG. 6 is a flowchart illustrating an example workflow for correlating wells in accordance with implementation of various technologies and techniques described herein.

FIG. 7 is a flowchart illustrating another example workflow for correlating wells in accordance with implementation of various technologies and techniques described herein.

FIG. 8 illustrates an example well top extraction operation performed on a graphical depiction of first and second well tracks.

FIG. 9 is a flowchart illustrating an example sequence of operations for interactively extracting well tops in accordance with implementation of various technologies and techniques described herein.

FIG. 10 is a flowchart illustrating an example sequence of operations for interactively interpreting seismic data in accordance with implementation of various technologies and techniques described herein.

FIG. 11 is a flowchart illustrating an example sequence of operations for integrating sparse data in accordance with implementation of various technologies and techniques described herein.

### DETAILED DESCRIPTION

The herein-described embodiments provide a method, apparatus, and program product that generate structural information for a subsurface formation based upon a stratigraphic implicit function of a volume based modeling structural framework of the subsurface formation.

In particular, in some embodiments of the invention, structural information, generally represented by one or more structural elements such as well tops, horizons, horizon interpretation objects, geological layer seismic attributes, faults, etc., may be generated for a subsurface formation, e.g., a geographical region of the Earth. A subsurface formation may include, for example, an on-shore or off-shore reservoir including recoverable hydrocarbons, and for the purposes of the disclosure, a volume of interest may refer to any volume in a geographical region of the Earth.

A stratigraphic implicit function may be considered to be a monotonously varying function that is based on stratigraphic age in the subsurface formation, and from which a value representative of stratigraphic age (e.g., relative geological age or relative stratigraphic thickness to a reference) may be determined based upon a three dimensional location in the subsurface formation, e.g., represented by Cartesian or other coordinates (e.g., (x, y, d), where x and y are geographical coordinates and d is depth below a reference depth such as the surface or sea level). For example a value representative of stratigraphic age may be a scalar attribute such as a Relative Geological Age (RGA) attribute in some embodiments of the invention. A stratigraphic implicit function is monotonously varying to the extent that it increases or decreases monotonously at least from an oldest horizon to a youngest horizon in a volume of interest. As will be appreciated by one of ordinary skill in the art having the benefit of the instant disclosure, a single value of the stratigraphic implicit function may define a conformable horizon surface throughout a volume of interest, and that, due to faults and other geological discontinuities (for example angular unconformities resulting from erosional processes or non deposition), such a surface may be discontinuous across such geological discontinuities. Moreover, in some embodiments (e.g., where there is no significant folding or faulting), within each conformable sequence a stratigraphic implicit function attribute may be proportional to the signed distance, or cumulative distance to, a reference surface, or to a ratio between a stratigraphic thickness separating two bounding surfaces and a stratigraphic thickness to one of the surfaces. Accordingly, in some embodiments, for a given value of the stratigraphic implicit function, a spatial distribution of that value may exist throughout at least a portion of a volume of interest in a subsurface formation.

A volume based modeling (VBM) structural framework generally refers to a structural framework incorporating a numerical model of a subsurface formation that principally models volumes (e.g., geological layers, fault blocks, geological bodies, etc.) as opposed to the surfaces bounding these volumes, and that is based at least in part on a stratigraphic implicit function as described above such that the distribution of the stratigraphic implicit function is known or can be interpolated everywhere within a volume of interest. In one example VBM structural framework, a structural framework may be constructed by building a tetrahedral mesh constrained by known faults in the subsurface formation, interpolating values of the implicit function on the nodes of the tetrahedral mesh (e.g., using a linear least squares formulation), and then generating surfaces representing implicitly modeled horizons based upon an iso-surfacing algorithm. The implicit function may in some embodiments be a stratigraphic implicit function.

In some embodiments consistent with the invention, a graphical depiction of subsurface formation data associated with the subsurface formation is generated and displayed to a user, and user input directed to that graphical depiction is used to specify a selection location relative to the graphical depiction. A graphical depiction, in this regard, is a visual or graphical representation of subsurface formation data such as well logs, two or three dimensional displays of a reservoir or subsurface formation (e.g., including visual representations of well paths of one or more existing or proposed wells), seismic traces, seismic images, seismic cubes, interpreted seismic horizons, faults and geological body boundaries (e.g. salt bag, dyke, etc.), interpreted well tops (i.e. intersections between well paths and subsurface elements), surfaces and maps extracted or interpolated from these interpretations, or other types of data that characterize the structure or other properties of a subsurface formation.

In such embodiments, the selection location relative to the graphical depiction may be used to determine a location in a volume of interest in the subsurface formation, such that a numerical model such as may be incorporated into a VBM structural framework may be accessed to determine a value of a stratigraphic implicit function associated with that numerical model corresponding to the determined location in the volume of interest. The determined value may then be used to generate at least one structural element for the subsurface formation, as well as to cause a graphical depiction of the at least one structural element to be displayed in the graphical depiction of the subsurface formation data. For example, in some embodiments, causing the graphical depiction of the at least one structural element to be displayed may include modifying the graphical depiction of the subsurface formation data to include the graphical depiction of a structural element or overlaying the graphical depiction of a structural element on the graphical depiction of the subsurface formation data, among other techniques.

It will be appreciated that, in some embodiments, causing a graphical depiction to be displayed may include the actual generation of graphical data that is displayed locally on a computer display coupled to a computer, e.g., in the case of a stand-alone or single-user computer system. In other embodiments, e.g., in client-server or web-based embodiments, causing a graphical depiction to be displayed may include generating data and/or instructions that, when communicated to a different computer, cause that computer to generate the graphical data that is ultimately displayed on a computer display coupled to that different computer.

In other embodiments, the determination of a location in a volume of interest may not be based upon user input directed to a graphical depiction, e.g., in instances where structural elements are generated in a batch process, structural data may be automatically be selected by applying a filter on a combination of attributes such as type of data (well top, seismic interpretation, etc.), absolute or relative stratigraphic age, geological type (e.g. erosion, fault, conformable horizon, etc.), name of geological formation, data support (well path, seismic survey), sub-volume or surface of interest (fault block, geological layer, arbitrarily defined bounding area or volume, arbitrary surface or intersection plane, etc.), value or range of one or several petrophysical or geometrical attribute(s) (depth, porosity, etc.), or as the geometrical intersection between existing structural elements (e.g. a well path and a surface, a map and a cross-section, etc.), etc. Moreover, it will be appreciated that in some embodiments, no graphical depictions may be generated for generated structural elements, and it may be sufficient that the structural elements are simply generated for use in later analysis or interpretation of a subsurface formation, or as input for the calculation of geometrical attributes (e.g. depth, thickness, etc.) or the construction of other structural elements, surfaces, maps, grids, meshes, etc. Thus, in some embodiments, a location in a volume of interest in a subsurface formation may be determined from subsurface formation data associated with the subsurface formation, a numerical model having a monotonously varying stratigraphic implicit function defined within the volume of interest may be accessed to determine a value of the stratigraphic implicit function corresponding to the determined location, and at least one structural element for the subsurface formation may be generated from the stratigraphic implicit function of the numerical model based upon a spatial distribution of the determined value within the volume of interest.

In one example embodiment, the techniques disclosed herein may be used to interactively generate well tops for a plurality of wells in a subsurface formation.

In such an embodiment, the graphical depiction of subsurface formation data may include a graphical depiction of subsurface formation data for each of first and second boreholes formed in the subsurface formation, the user input may include user selection of a first proposed well top for the first borehole on the graphical depiction of subsurface formation data for the first borehole, the location of the user input may include a depth along the first wellbore corresponding to the user selection of the first proposed well top, accessing the numerical model to determine the value of the stratigraphic implicit function may include determining the value of the stratigraphic implicit function at the depth along the first borehole, generating at least one structural element may include generating, for the second borehole, a second proposed well top corresponding to the first proposed well top for the first borehole based upon the determined value of the stratigraphic implicit function, and causing the at least one structural element to be displayed in the graphical depiction of the subsurface formation data may include causing a graphical depiction of the second proposed well top to be displayed on the graphical depiction of subsurface formation data for the second borehole.

In some embodiments, the graphical depictions of subsurface formation data for the first and second boreholes may each include a well track of a well log, while in some embodiments, the graphical depictions of subsurface formation data for the first and second boreholes may each include a well path in a three dimensional view.

In some embodiments, the subsurface formation data may include subsurface formation data for each of first and second boreholes formed in the subsurface formation, the location in the volume of interest may include a depth along the first wellbore corresponding a first proposed well top for the first borehole, accessing the numerical model to determine the value of the stratigraphic implicit function may include determining the value of the stratigraphic implicit function at the depth along the first borehole, and generating at least one structural element may include generating, for the second borehole, a second proposed well top corresponding to the first proposed well top for the first borehole based upon the determined value of the stratigraphic implicit function.

Further embodiments may also include sampling the stratigraphic implicit function along each of first and second well paths respectively corresponding to the first and second boreholes, where accessing the numerical model to determine the value of the stratigraphic implicit function may include determining the value from the sampled stratigraphic implicit function along the first well path, and generating the second proposed well top may include generating a location of the second proposed well top from the sampled stratigraphic implicit function along the second well path. In some such embodiments, sampling may include sampling at substantially regular depths along the first and second well paths. In other such embodiments, the numerical model may include a tetrahedral mesh, and sampling may include sampling at intersections between the first and second well paths and faces of the tetrahedral mesh. In other such embodiments, sampling may include taking at least one sample proximate an intersection between the first or second well path and a discontinuity, a fault or a conformable horizon defined in the numerical model.

In some embodiments, after generating a second proposed well top based upon the determined value of the stratigraphic implicit function, a location of the second proposed well top may be automatically adjusted based upon first and second petrophysical logs respectively associated with the first and second boreholes. In some such embodiments, automatically adjusting the location of the second proposed well top may include iteratively perturbing an offset or a stretch/squeeze factor and correlating the first and second petrophysical logs in a vicinity of the first and second proposed well tops.

In addition, in some embodiments, the at least one structural element may include a geological map of an intermediate geological horizon, and in some embodiments, the intermediate geological horizon is not used to constrain the numerical model prior to being generated.

In some embodiments, the subsurface formation data may include a seismic image, the location in the volume of interest may correspond to a point in the seismic image, accessing the numerical model to determine the value of the stratigraphic implicit function may include determining the value of the stratigraphic implicit function at the point in the seismic image, and generating at least one structural element may include generating a surface or a plurality of points in the seismic image based upon the determined value of the stratigraphic implicit function.

Further, in some embodiments, determining the location in the volume of interest may include determining a plurality of locations in the volume of interest, accessing the numerical model to determine the value of the stratigraphic implicit function may include determining the value of the stratigraphic implicit function for each of the determined plurality of locations and determining a residual for each of the determined plurality of locations from the determined value for each of the plurality of locations, and generating at least one structural element may include generating a surface or a plurality of points based upon the determined value and determined residual for each of the plurality of locations. In some embodiments, the residual at one location may be computed as the difference between the value of the implicit function at this location and an average (e.g. arithmetic, geometric, harmonic mean or median), a representative (e.g. minimum, maximum) value determined from values of the implicit function sampled at a plurality of locations, or as the difference between the value of the implicit function at this location and an arbitrarily selected value. In some embodiments, this residual may be interpolated in a volume of interest containing the plurality of locations, and a refined, updated or corrected implicit function may be obtained by adding the interpolated residual to the original implicit function. In some embodiments, the interpolated value of the residual may further be constrained to be null at a plurality of locations determined by previously modeled or interpreted data (well tops, seismic horizons, etc.). In some embodiments, the interpolation may be performed by deterministic algorithms such as kriging, discrete smooth interpolation, inverse distance, etc. In other embodiments, the interpolation of the residual may be performed using a stochastic geostatistical algorithm such as Sequential Gaussian Simulation, Gaussian Random Function Simulation, etc., allowing generation of a plurality of equiprobable interpolated residual cubes. In some embodiments, this interpolation may be discontinuous across some of the faults and unconformity surfaces. In some embodiments, structural elements may be extracted from the refined, updated or corrected implicit function and from an average value of the implicit function determined from the plurality of input locations.

Some embodiments may also include an apparatus including at least one processing unit and program code configured upon execution by the at least one processing unit to generate structural information for a subsurface formation in any of the manners discussed herein. Some embodiments may also include a program product including a computer readable medium and program code stored on the computer readable medium and configured upon execution by at least one processing unit to generate structural information for a subsurface formation in any of the manners discussed herein.

Other variations and modifications will be apparent to one of ordinary skill in the art.

### Hardware and Software Environment

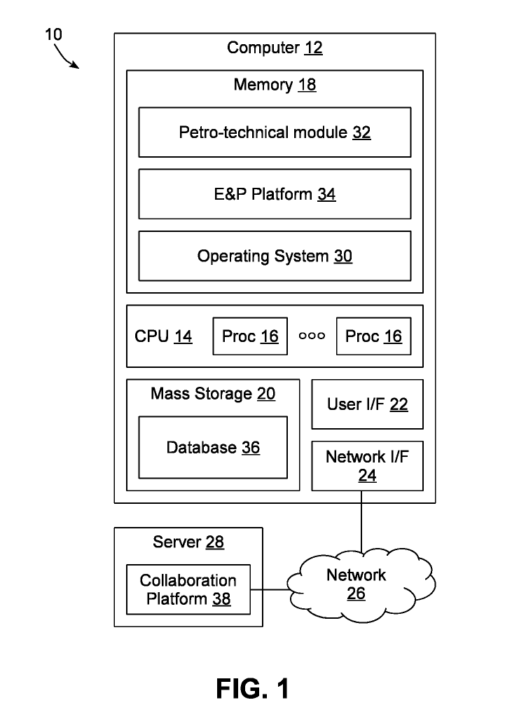

Turning now to the drawings, wherein like numbers denote like parts throughout the several views, FIG. 1 illustrates an example data processing system 10 in which the various technologies and techniques described herein may be implemented. System 10 is illustrated as including one or more computers 12, e.g., client computers, each including a central processing unit (CPU) 14 including at least one hardware-based processor or processing core 16. CPU 14 is coupled to a memory 18, which may represent the random access memory (RAM) devices comprising the main storage of a computer 12, as well as any supplemental levels of memory, e.g., cache memories, non-volatile or backup memories (e.g., programmable or flash memories), read-only memories, etc. In addition, memory 18 may be considered to include memory storage physically located elsewhere in a computer 12, e.g., any cache memory in a microprocessor or processing core, as well as any storage capacity used as a virtual memory, e.g., as stored on a mass storage device 20 or on another computer coupled to a computer 12.

Each computer 12 also generally receives a number of inputs and outputs for communicating information externally. For interface with a user or operator, a computer 12 generally includes a user interface 22 incorporating one or more user input/output devices, e.g., a keyboard, a pointing device, a display, a printer, etc. Otherwise, user input may be received, e.g., over a network interface 24 coupled to a network 26, from one or more external computers, e.g., one or more servers 28 or other computers 12. A computer 12 also may be in communication with one or more mass storage devices 20, which may be, for example, internal hard disk storage devices, external hard disk storage devices, storage area network devices, etc.

A computer 12 generally operates under the control of an operating system 30 and executes or otherwise relies upon various computer software applications, components, programs, objects, modules, data structures, etc. For example, a petro-technical module or component 32 executing within an exploration and production (E&P) platform 34 may be used to access, process, generate, modify or otherwise utilize petro-technical data, e.g., as stored locally in a database 36 and/or accessible remotely from a collaboration platform 38. Collaboration platform 38 may be implemented using multiple servers 28 in some implementations, and it will be appreciated that each server 28 may incorporate a CPU, memory, and other hardware components similar to a computer 12.

In one non-limiting embodiment, for example, E&P platform 34 may implemented as the PETREL Exploration & Production (E&P) software platform, while collaboration platform 38 may be implemented as the STUDIO E&P KNOWLEDGE ENVIRONMENT platform, both of which are available from Schlumberger Ltd. and its affiliates. It will be appreciated, however, that the techniques discussed herein may be utilized in connection with other platforms and environments, so the invention is not limited to the particular software platforms and environments discussed herein.

In general, the routines executed to implement the embodiments disclosed herein, whether implemented as part of an operating system or a specific application, component, program, object, module or sequence of instructions, or even a subset thereof, will be referred to herein as “computer program code,” or simply “program code.” Program code generally comprises one or more instructions that are resident at various times in various memory and storage devices in a computer, and that, when read and executed by one or more hardware-based processing units in a computer (e.g., microprocessors, processing cores, or other hardware-based circuit logic), cause that computer to perform the steps embodying desired functionality. Moreover, while embodiments have and hereinafter will be described in the context of fully functioning computers and computer systems, those skilled in the art will appreciate that the various embodiments are capable of being distributed as a program product in a variety of forms, and that the invention applies equally regardless of the particular type of computer readable media used to actually carry out the distribution.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, DVD, or other optical storage, magnetic cassettes, magnetic tape, magnetic disk storage or other magnetic storage devices, or any other medium that can be used to store the desired information and which can be accessed by computer 10. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Furthermore, it will be appreciated by those of ordinary skill in the art having the benefit of the instant disclosure that the various operations described herein that may be performed by any program code, or performed in any routines, workflows, or the like, may be combined, split, reordered, omitted, and/or supplemented with other techniques known in the art, and therefore, the invention is not limited to the particular sequences of operations described herein.

Those skilled in the art will recognize that the example environment illustrated in FIG. 1 is not intended to limit the invention. Indeed, those skilled in the art will recognize that other alternative hardware and/or software environments may be used without departing from the scope of the invention.

### Oilfield Operations

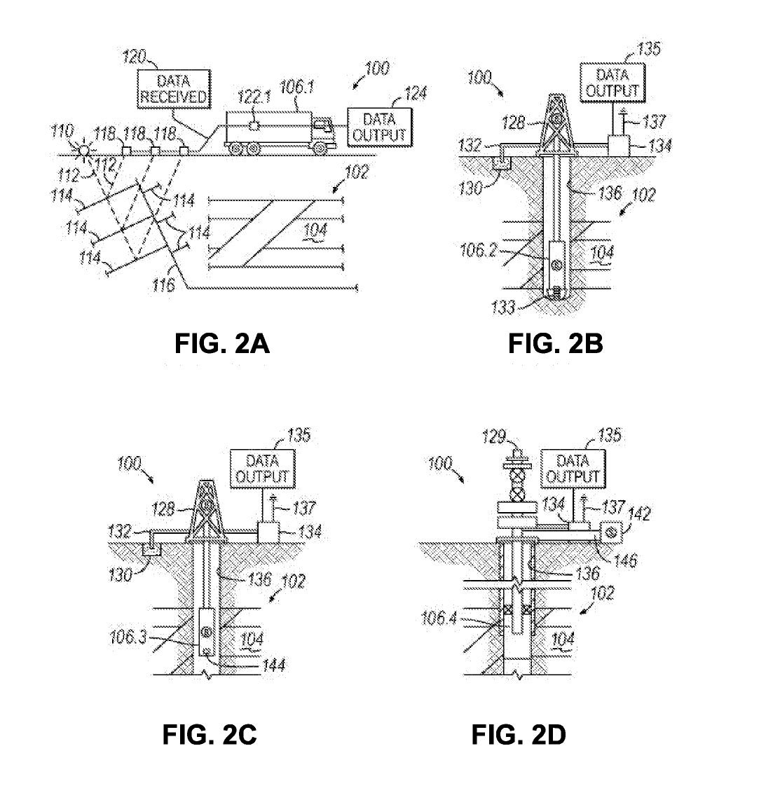

FIGS. 2A-2D illustrate simplified, schematic views of an oilfield 100 having subterranean formation 102 containing reservoir 104 therein in accordance with implementations of various technologies and techniques described herein. FIG. 2A illustrates a survey operation being performed by a survey tool, such as seismic truck 106.1, to measure properties of the subterranean formation. The survey operation is a seismic survey operation for producing sound vibrations. In FIG. 2A, one such sound vibration, sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 2B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud may be filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Generally, the wellbore is drilled according to a drilling plan that is established prior to drilling. The drilling plan sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 2C illustrates a wireline operation being performed by wireline tool 106.3 suspended by rig 128 and into wellbore 136 of FIG. 2B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 2A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 2D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 2B-2D illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 2A-2D are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites.

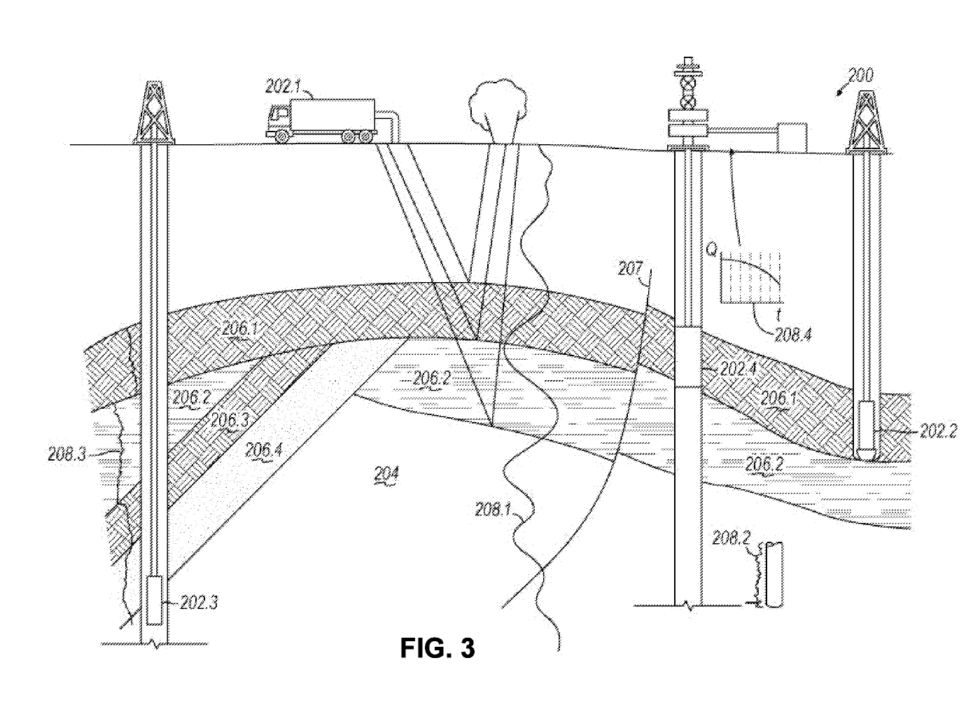

FIG. 3 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 2A-2D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that generally provides a resistivity or other measurement of the formation at various depths.

A production decline curve or graph 208.4 is a dynamic data plot of the fluid flow rate over time. The production decline curve generally provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, generally below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 3, may then be processed and/or evaluated. Generally, seismic data displayed in static data plot 208.1 from data acquisition tool 202.1 is used by a geophysicist to determine characteristics of the subterranean formations and features. The core data shown in static plot 208.2 and/or log data from well log 208.3 are generally used by a geologist to determine various characteristics of the subterranean formation. The production data from graph 208.4 is generally used by the reservoir engineer to determine fluid flow reservoir characteristics. The data analyzed by the geologist, geophysicist and the reservoir engineer may be analyzed using modeling techniques.

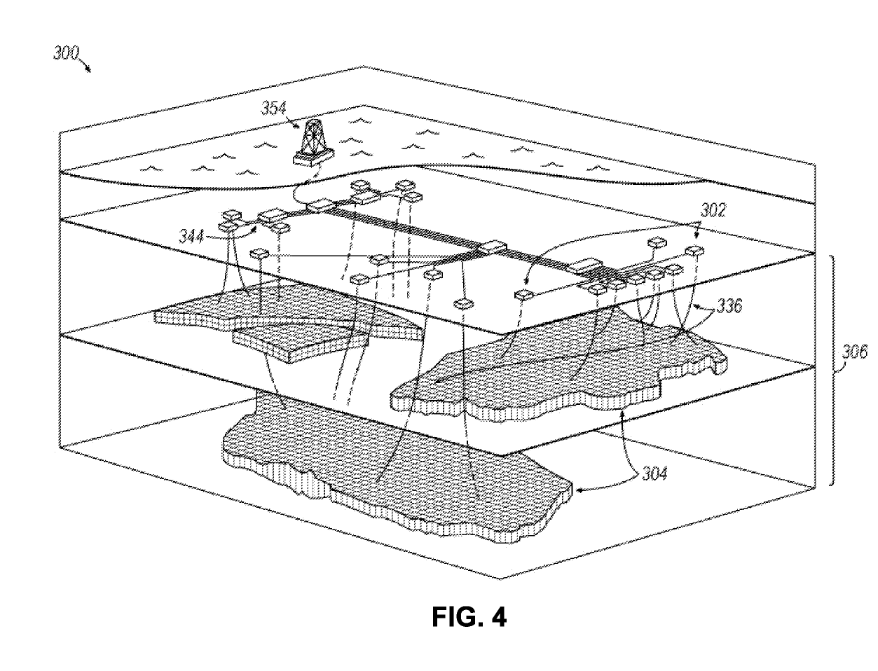

FIG. 4 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 4 is not intended to limit the scope of the oilfield application system. Part or all of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

### Generation Of Structural Elements For Subsurface Formation Using Stratigraphic Implicit Function

Embodiments consistent with the invention may be used to generate structural information for a subsurface formation based upon a stratigraphic implicit function of a volume based modeling structural framework of the subsurface formation. In one embodiment discussed hereinafter, for example, an interactive process may be used in connection with well correlation to determine well tops corresponding to the intersection of multiple well boreholes with a geographical layer (or horizon representing the same). The embodiments discussed hereinafter will focus primarily on well correlation, as well as an interactive process; however, as will become more apparent below, the invention may also be utilized in connection with determining other structural elements in a subsurface formation, as well as in non-interactive processes. Therefore, the invention is not limited solely to the interactive well correlation applications discussed further herein.

As noted above, well tops are traditionally interpreted at the intersection between a well path and the boundary between two geological layers (i.e., a geological horizon). One conventional method for interpreting well tops relies on searching for sharp changes of petrophysical properties (e.g., porosity) that reveal a change in geological facies of the rocks penetrated by the borehole of a well. The process of identifying/recognizing a given geological horizon along several wells is generally referred to as well correlation, and this process generally relies on a set of petrophysical logs (e.g., porosity neutron, gamma ray, etc.) and looks for similar patterns, i.e., types of variations, on the various logs. To ease the correlation, an iterative approach may be employed, where the most obvious stratigraphic interfaces are identified first, and then used as a reference to correlate less obvious interfaces.

For example, well correlation may be performed by displaying all the well tracks and associated logs side-by-side in a single graphical window on a computer, manually adjusting the offset, scale and local stretch of the displayed logs so that reference markers are “flattened” at the same reference depth for all logs, and then using “true stratigraphic thickness” (i.e., thickness measured perpendicularly to the geological layers) to visualize the depth of both logs and well markers. However, in the presence of horizontal wells that alternately up- and down-dip and/or in presence of geological faults crossing the wells, it may be difficult to accurately compute the “true stratigraphic thickness” of a geological layer. Moreover, not all useful petrophysical logs may have been measured in all wells, and reliance on well logs may be hampered by the fact that the observed petrophysical “patterns” generally become more dissimilar as the distance between wells increases.

In some instances, well correlation is integrated with three dimensional (3D) reservoir modeling, and follows a linear process that cascades from the interpretation and correlation of well tops (which is generally performed based on the observation of petrophysical logs), to the creation of a 3D model that integrates geometrical and stratigraphic information coming from the well tops to adjust the geometry of 3D horizon surfaces.

Integrating information coming from the 3D model back into the well correlation process is generally much more complex. In particular, integrating information related to intermediate horizons, i.e., horizons located in between seismically interpreted horizons, generally involves building a 3D reservoir grid (e.g., a corner point grid) from which the intermediate horizon can be extracted, so that the intersection between this intermediate horizon and the wells can be computed. The 3D grid building process may involve intensive user interactions and excessive simplification of the input model, which may also negatively impact the geometry of extracted horizons.

In some embodiments consistent with the invention, on the other hand, well correlation may be performed in an interactive manner that relies on stratigraphic information contained in a structural framework model built using a VBM (Volume Based Modeling) technology. Doing so effectively enables the knowledge of relative stratigraphic age substantially throughout a volume of interest in a subsurface formation to be used in the well correlation process. In some embodiments, doing so enables a tighter loop to exist between well top extraction and correlation and modeling, as new well tops may be extracted directly from the structural framework.

VBM technology may be used to directly model volumes (e.g., geological layers) rather than surfaces (e.g., the horizons that are bounding geographical layers). The approach generally relies on the concept of “implicit modeling”, in which surfaces are represented as iso-values of a volume attribute generally referred to as the implicit function. The volume attribute may be defined throughout a volume of interest and may represent the stratigraphic age of the formation.

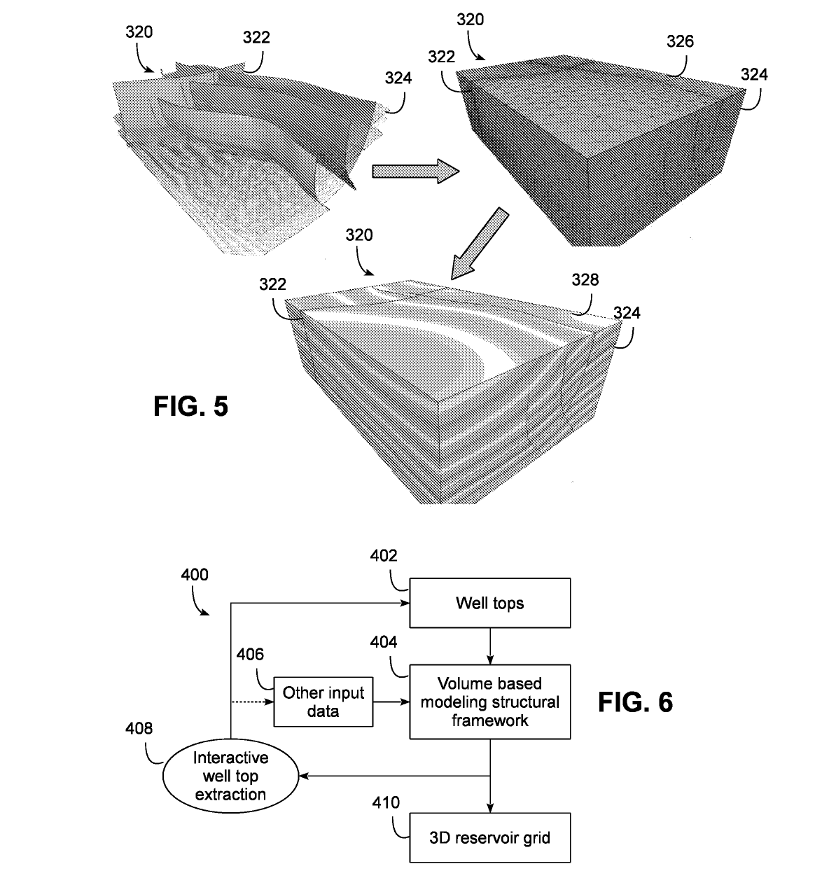

As illustrated in FIG. 5, a structural framework 320 may be initially defined by faults 322 and horizons 324, determined, for example, via seismic surveys, or in other known manners. A tetrahedral mesh 326 is constructed, constrained by the existing faults 322 and horizons 324, for carrying the implicit function. Then, the values of the implicit function are interpolated on the nodes of the tetrahedral mesh, as illustrated by the shading at 328. Using an iso-surfacing algorithm, an implicitly modeled surface may then be generated for each horizon, thereby resulting in a consistent zone model for the overall subsurface formation.

The implicit function allows for building structural models based on a tetrahedral mesh constrained by input data (e.g., fault, well top and/or horizon interpretations). Such models may be used as the starting point for the construction of 3D reservoir grids. One limitation with such models, however, is that extracting additional horizons has generally demanded a horizon modeling process to be repeated with additional input data (e.g., a single well top), which can be impractical and time consuming. Generally, the existing extraction process does not allow for interactive, e.g., in real time or near real time, generation of a consistent faulted horizon surface passing through an arbitrarily selected point.

For example, as illustrated by workflow 400 of FIG. 6, well correlation consistent with some embodiments of the invention may be performed to determine well tops 402 in an interactive matter and in conjunction with construction of a volume based modeling (VBM) structural framework 404 (based upon the well tops 402 as well as additional input data 406 such as interpreted faults and horizons) through the introduction of an interactive well top extraction workflow 408. Notably, the interactive process may be prior to generation of a 3D reservoir grid 410, in contrast with some existing workflows.

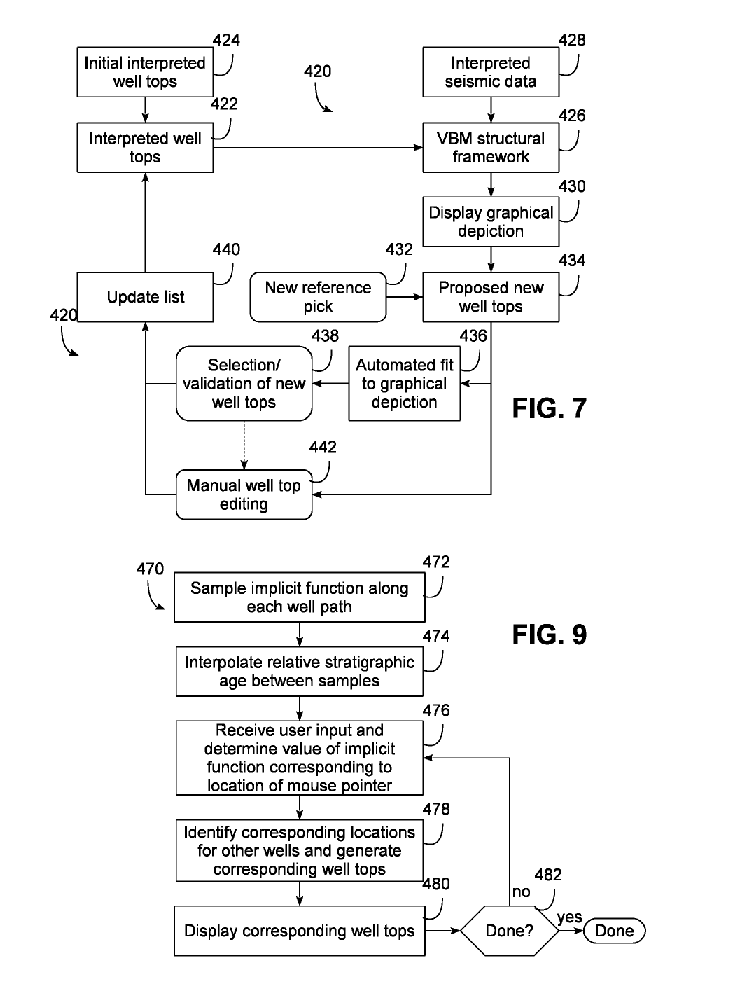

FIG. 7 illustrates additional details of an example workflow 420 consistent with some embodiments of the invention. Initially, a set of interpreted well tops 422 may be populated with a set of initial interpreted well tops 424, e.g., well tops determined via obvious correlations seen in well logs. A VBM structural framework 426 may then be built from the interpreted well tops 422 and interpreted seismic data 428 (e.g., including faults and/or horizons).

Based upon the VBM structural framework, a graphical depiction of subsurface formation data is generated and displayed to a user (block 430). The graphical depiction may include any suitable graphical display of relevant subsurface formation data, e.g., a 2D or 3D display of the VBM structural framework with representations of the well paths of any existing and/or proposed wells, a set of well tracks (i.e., graphs of well logs oriented along a vertical axis corresponding to depth), etc.

Next, a user may pick a new reference well top (block 432) from the graphical depiction, resulting in the generation of one or more corresponding proposed new well tops (block 434) and the automated fit of the proposed new well tops on the graphical depiction, e.g., via overlaying graphical depictions of the proposed new well tops on the graphical depiction of the subsurface formation data (block 436).

Next, in block 438 the user may review the locations of the automatically added well tops on the active/selected wells and validate, modify and/or discard the interpolated well tops. Well tops may also be renamed in some embodiments. A tool such as Visual QC, available from Schlumberger Ltd. and its affiliates, may be used to validate or discard automatically added well tops. In some embodiments, validated well tops may be flagged such that they will be consumed by modeling algorithms, while non-validated tops may be ignored while building a 3D model.

Next, in block 440, validated well tops may be added to the set of interpreted well tops 422 to be used for the modeling and to the inputs of the VBM structural framework 426. In addition, the validated well tops may be added to any displayed stratigraphic column in a graphical depiction. The aforementioned operations may also be repeated, thereby enabling a user to interactively generate new well tops.

In addition, as illustrated in block 442, manual editing of well tops may be performed, e.g., to adjust the locations of the proposed new well tops from the initially generated locations. For example, in some embodiments, proposed new well tops may be overlaid on well tracks, and a user may snap the computed well tops to their most likely actual localization along the well tracks, e.g., based on correlation between the well logs of the original reference well and the corresponding well logs on other active/selected wells. In addition, in some embodiments, any manually edited top may be considered as “validated” by the user.

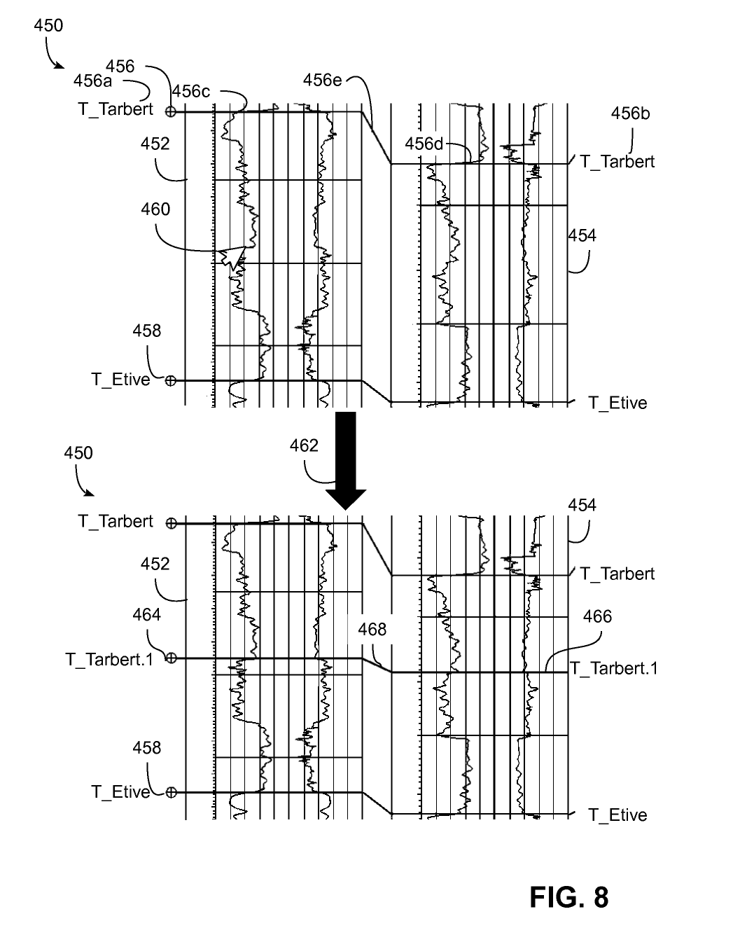

In one embodiment, for example, an interactive well correlation tool or plug-in, e.g., implemented as petro-technical module 32 of E&P platform 34 (FIG. 1), may be used to perform interactive well top extraction in the manner disclosed herein. In such an embodiment, and as shown in FIG. 8, a user may be presented with a graphical depiction 450 of a series of well tracks (e.g., well tracks 452 and 454) displaying well logs of a plurality of wells. Existing well tops may be represented as illustrated at 456 and 458, e.g., including an identifier or name for the well top (e.g., identifiers 456a and 456b), a horizontal line segment (e.g., line segments 456c and 456d) corresponding to the depth of the well top in each well track 452, 454, and an additional line segment 456e graphically linking the horizontal line segments 456c, 456d to visually represent the correspondence of the two well tops.

As illustrated in the top half of FIG. 8, a user may position a mouse pointer 460 at a desired location on graphical depiction 450, corresponding to a particular depth for a reference well represented by well track 452, and thus a particular location in the subsurface formation. Then, by clicking or otherwise indicating a user's selection of the desired location (represented at 462), both a graphical depiction 464 of the selected well top on the well track 452 for the reference well, and a graphical depiction 466 of a corresponding proposed new well top on well track 454, may be displayed. Notably, graphical depictions 462, 464 may include identifiers and horizontal line segments joined by a linking line segment, similar to that described above for graphical depiction 456.

Other manners of visually representing a well top may be used in other embodiments. For example, where a 3D or 2D representation of a subsurface formation is displayed, and well paths are displayed for wells in the subsurface formation, well tops may be represented by markers at the associated depths along the graphical depictions of the well paths. A well top may also be displayed in a map or a stereonet. To display it in a stereonet, for example, a dip angle and dip azimuth may be extracted from the implicit function at the well top location (dip angle and dip azimuth may be extracted, for example, from the gradient of the implicit function).

In some embodiments, the display of well tops may occur prior to a user clicking at a particular location on a graphical depiction. For example, in some embodiments, whenever a user hovers a mouse cursor over a given well track (corresponding to a reference well), a “ghost” well top may be displayed at the corresponding depth of the mouse on the well track on which the mouse is located, and the corresponding well top(s) on other active and/or selected wells in a project may likewise be displayed as additional “ghost” well tops. Movement of a mouse pointer to different depths along a reference well track may result in the locations of the corresponding well tops dynamically updating to follow the change in depth. Then, upon clicking or selecting a particular location, the “ghost” well tops may change in appearance to represent the user selection of the location.

It will be appreciated that other graphical depictions may be used to indicate the locations of well tops in a graphical depiction of subsurface formation data, generally based at least in part on the type of subsurface formation data, the type of E&P platform and other factors that will be apparent to one of ordinary skill in the art having the benefit of the instant disclosure.

Returning to FIG. 5, as noted above the correspondence between well tracks may be based at least in part on the relative stratigraphic time information contained in a VBM structural framework or model. The VBM structural framework may be configured as a coarse tetrahedral solid associated with a set of fine triangulated surfaces representing geological horizons, and the “relative stratigraphic time” information may be represented as illustrated at 328 by the combination of a “stratigraphy” property stored at the nodes of the tetrahedral mesh and interpolated linearly within each tetrahedron, associated with an “offset” corresponding to the discrepancy between the fine scale surfaces and the coarse tetrahedral mesh.

Now turning to FIG. 9, this figure illustrates an example routine 470 for extracting corresponding well tops based upon a stratigraphic implicit function. As illustrated in block 472, to enable interactive well correlation, the stratigraphic implicit function of a VBM structural framework (i.e., relative stratigraphic age) may be first sampled along each well path, and associated with various wells (e.g. as a new well log). Different sampling strategies may be used in different embodiments. For example, samples may be taken at regularly spaced intervals along measured depth, and/or samples may be taken at the intersections between a well path and the faces of the tetrahedral mesh. In addition, in some embodiments, additional samples may be added at the intersections between wells and discontinuities such as faults and unconformities and/or at the intersections with conformable horizons.

The relative stratigraphic age may then be interpolated, e.g. linearly, between the various samples (block 474). In addition, in some embodiments, the gradient of relative stratigraphic age may be sampled from a 3D volume to the well logs.

Next, localization of well tops along selected/active well paths is performed in response to user input by determining, from the sampled data, the value of the implicit function at the location (depth) of the mouse pointer along the well path of the reference well (block 476), i.e., within the graphical depiction of subsurface formation data corresponding to the reference well. It will be appreciated that a reference well may be defined statically, such that all user input in connection with extracting well tops is directed at the graphical depiction of the subsurface formation data for that well. In other embodiments, however, the reference well may be dynamic and may be considered to be the well associated with the graphical depiction with which the user interacts at any given time.

Next, in block 478, locations corresponding to the same value of the implicit function (or at least within a range of the value of the implicit function) are then used to generate structural elements, e.g., well tops, for each other well of interest (e.g., all visible wells, all selected wells, all active wells, etc.). Graphical depictions of the structural elements are then generated and displayed with the graphical depictions of the subsurface formation data corresponding to each other well of interest in block 480. It will be appreciated that there may be zero or several corresponding locations on any of the other wells of interest depending on the geometries of such wells.

Routine 470 may be interactive in nature, and accordingly, if the user wishes to extract additional well tops, block 482 passes control back to block 476 to receive additional input from a user specifying another location along a well path. When the user is finished with extracting well tops, block 482 terminates routine 470.

As also noted above in connection with block 436 of FIG. 7, it may be desirable in some embodiments to additionally perform an automated fit to well logs, e.g., petrophysical logs, after proposing new well tops in the manner described above in connection with FIG. 9. In some instances, generating a well top based exclusively on the value of an implicit function may identify a location that is close to the optimal localization of the well top along the well, but through further refinement to accommodate local variations of relative thicknesses of the geological layers, a more accurate location may be determined. In some embodiments, such an adjustment may be performed automatically by finding the offset and stretching/squeezing factor on the target well for which the pattern defined by a selected petrophysical well log (or multiple logs) is the most similar to the patterns observed on the reference well.

For example, in one embodiment, the base offset may be given by the localization of the “initial guess” well top, corresponding to the location on the processed well for which the relative stratigraphic age is the same as the user selection location of the reference well top on the reference well. The base stretch/squeeze factor between the reference and the processed well may be given by the ratio between gradients of the implicit function at the location of the reference and corresponding well tops.

The adjustment may then incorporate an iterative optimization process where the value of the offset and/or the stretch/squeeze factor are slightly perturbed, and a local search is performed for the optimal correlation between petrophysical logs on the reference and selected wells in the vicinity of the reference/corresponding well tops. Once an optimal local correlation is found, the new offset value may then be used to update the location of the corresponding well top on the processed well. The process may then be repeated on each other well of interest. In such a process, the inputs may include:
a maximum offset value (in MD), expressed as the absolute value of the difference with the base offset. In case the distance between the processed top and a previously validated top would be lower than the maximum offset value, the maximum offset value would be automatically lowered;
a maximum stretch/squeeze factor, expressed as the absolute value of the difference with the base stretch/squeeze factor; and
a length of the window considered for correlation (on the reference well).
   The process may then attempt to minimize a cost such that:
The cost increases with the difference between computed offset and stretch and base offset and stretch;
The cost decreases with the similarity of logs on the reference and on the processed wells; and
The cost is a weighted sum of costs computed each of the input petrophysical logs. The weights may be deduced from the calculation of correlation between these logs along a window located around any manually interpreted well tops (e.g., the “initial interpreted well tops” referenced in block 424 of FIG. 7).

Various techniques for calculating the correlation and/or the optimal offset/stretch (e.g., dynamic time wrapping, convolution, approximation by trigonometric polynomials or wavelets, etc.) may be used, as will be appreciated by those of ordinary skill in the art having the benefit of the instant disclosure.

As noted above, the iterative process described herein may be utilized to generate different types of structural information for a subsurface formation in some embodiments of the invention. For example, in some embodiments, intermediate horizon surfaces (i.e., horizons not used initially to constrain the construction of the VBM structural framework) may be extracted using the herein-described techniques to generate one or more geological maps (i.e., faulted surfaces). In particular, surfaces corresponding to iso-values of the relative-stratigraphic time may be interactively extracted from the VBM structural framework, e.g., as triangulated surfaces, and visually represented as geological maps. The surfaces may be such that they pass through an existing or new set of well tops and/or such that they subdivide a given stratigraphic interval in an arbitrary number of sub-intervals of equal true stratigraphic thickness.

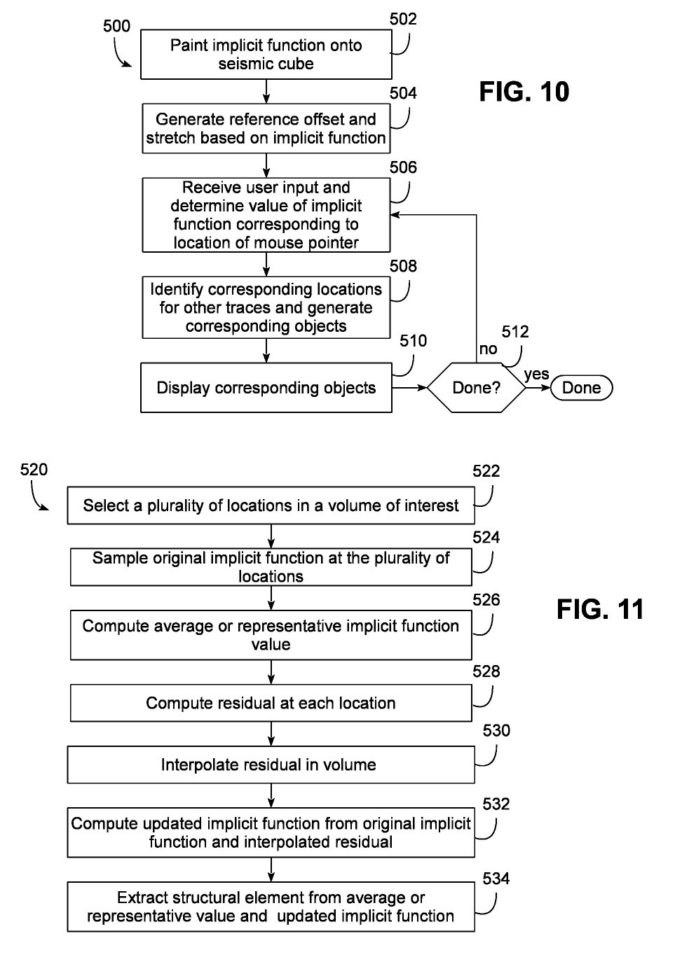

In other embodiments, the iterative process described herein may be used in connection with guided seismic horizon interpretation, such that instead of using well paths and/or well logs, a seismic well traces may be considered and used to construct new “horizon interpretation” objects or “geological layer” seismic attributes representing seismic events from the implicit function. As illustrated by routine 500 of FIG. 10, for example, well traces maybe correlated by first “painting” the stratigraphic implicit function onto a seismic cube in block 502, e.g., by interpolating the implicit function from the tetrahedral mesh to nodes or voxels of the seismic cube (e.g., using a linear least formulation based on the barycentric coordinate of the seismic node in the tetrahedron containing this node). Next, in block 504, a reference correlation (offset and stretch) between neighbor well traces may be generated based upon the implicit function to provide an initial guess for correlating the neighbor well traces.

Next, in response to user input, e.g., a mouse click, the value of the implicit function at the location of the mouse pointer along a reference well trace (representative of a time/depth in the well trace) is determined (block 506). Next, in block 508, locations corresponding to the same value of the implicit function (or at least within a range of the value of the implicit function) are then used to generate structural elements, e.g., horizon interpretation objects, representing corresponding seismic events for other well traces of interest (e.g., all visible well traces, all neighboring well traces, selected well traces, all active well traces, etc.). Graphical depictions of the corresponding structural elements (objects) are then generated and displayed with the graphical depictions of the well traces in block 510. Block 512 may then determine if the user is done with seismic interpretation, and if not, returns control to block 506. If no further interpretation is to be performed, however, routine 500 is complete.

More generally, routine 500 may be considered to be of use in generating structural elements such as a surface or a plurality of points in a seismic image, e.g., a seismic cube, based upon a determined value of a stratigraphic implicit function correlated to a location in a volume of interest based upon a selected point in the seismic image.

In some embodiments, for example, each iso-value of a relative stratigraphic age (RGA) attribute may be considered to potentially correspond to a geological horizon, i.e., to the interface between two geological layers. The RGA attribute may be used to guide seismic interpretation, e.g., visually through an interactive process, or as an additional constraint when performing seismic auto-tracking Conventionally, auto-tracking is performed by comparing neighbor seismic traces and looking for the optimum vertical offset that yields maximum similarity between those traces in the vicinity of a given seismic horizon, with the optimum offset selected based on the value of the offset itself (which may be constrained to be consistent with a pre-computed local dip), the value of the “similarity” (i.e., correlation) between seismic traces once the offset has been removed, and limited stretching/squeezing that may also be applied to either trace to maximize similarity. When an implicit function/RGA attribute is used for guiding auto-tracking, however, the RGA attribute may provide both a reference offset (e.g., based on the dip of the picked surface) and a reference squeezing/stretching (e.g., based on the gradient difference) for the similarity search. Moreover, the RGA attribute may allow for correlating traces across faults. Furthermore, in some embodiments, when a seismic-scale RGA attribute has been computed, it may also be possible to simply “snap” iso-surfaces of the attribute to the closest peak, trough, or zero-crossing of the seismic signal on each trace to obtain an automated interpretation, without resorting to auto-tracking

In other embodiments, structural elements may be generated based on sparse data. In such embodiments, instead of extracting directly an iso-value of the implicit function, a value extracted from the implicit function may be combined with a residual value (also referred to herein as a “residual”), or from an implicit function that has been updated. In such embodiments, rather than determining the location of one unique location in the volume of interest, a set of locations (e.g. a set of well tops that correspond to the same horizon) may be determined and used to generate a surface or a plurality of points based upon both the implicit function values and the residual values for the set of locations. The relative geological age attribute may be used to replace isochore or isopach based workflows when computing a geologically consistent structural model of a subsurface formation. In particular, it may be used to interpolate the location of geological interfaces defined by sparse and/or incomplete data (e.g. well tops). In the process, the relative geological age attribute itself may even be updated to account for the sparse data.

In one example embodiment, the general process for integrating sparse data in the model may be as follows:

First, a residual may be computed between an initial estimate of the relative geological age (RGA) and an attribute that would incorporate the sparse data, e.g., by computing relative geological age from dense interpretations only (i.e., an initial estimate), for each horizon based on sparse data, estimating relative geological age (e.g., by averaging values of the initial estimate at the location of the sparse data) and at the location of each sparse data point, computing a residual between the estimated RGA and the initial estimate, and interpolating the residual with the following constraints (each of which may be represented as a set of linear equations):

Honor residual value computed above at the location of the sparse data points, either for one horizon at a time or of all horizons together;
Enforce a null residual at the location of dense interpretations;
Optionally, enforce a null residual far from any data, or in fault blocks that do not contain any data;
Optionally, enforce a null residual on model external or internal boundaries;
Ensure smoothness of the residual (e.g. through the application of an harmonic constraint); and
Ensure smoothness of [residual+initial estimate] and of its gradient (e.g., through a smooth gradient constraint, with the “unknown” values being those of the residual).

Next, the residual may be summed with the initial estimate to obtain the final value of the relative geological age, from which the iso-surfaces corresponding to the sparse data can be extracted, or the reference dense data may be moved and used to re-compute an implicit function.

In the latter instance, the residual may be summed with the initial estimate, and the relative geological age of an arbitrary reference horizon defined by a dense interpretation may be subtracted. The computed difference and the gradient of the [initial estimate+residual] may be used to compute a 3D offset (i.e. vector field) that would move all points of the reference horizon to the target surface. An offset point may be created using the reference dense interpretation plus the computed vector field. The aforementioned operations may then be repeated for each horizon based on sparse data. A final implicit function may then be computed based on the original data points and the offset points.

As illustrated by routine 520 of FIG. 11, for example, sparse data may be integrated into a model in one embodiment by first selecting a plurality of locations for the purpose of extracting new structural elements from a model (block 522). In various embodiments, for example, locations (e.g. well tops, seismic picks, etc.) may be selected interactively from a graphical depiction of subsurface data or automatically, e.g. by applying a combination of filters on available input data. Next, in block 524, an implicit function may be sampled, or interpolated, at these various locations, yielding a scalar value (e.g. a relative geological age) per location. An average or representative value (e.g. median, arithmetic mean, etc.) may be computed from the sampled or interpolated values (block 526), and for each selected point, a “residual” value may be computed (block 528), e.g., by subtracting the average or representative value from the value initially sampled or interpolated in block 524.

The residual computed in block 528 may then be interpolated in the volume of interest, e.g., using a stochastic (e.g., sequential gaussian simulation) or deterministic (e.g., kriging) interpolation technique (block 530). In some embodiments, additional data points (e.g. well tops, seismic interpretation points, etc.) may also be used to constrain the residual to a value of zero at some locations of the model. The resulting “residual” may be considered to be a scalar attribute or property, the value of which is known, or may be computed, in the entire volume of interest.

Next, in block 532, an updated implicit function may be computed from the initial implicit function and the residual, e.g., by adding scalar values of the initial implicit function and of the residual to produce a new field of scalar value, e.g., defined at the nodes of a 3D mesh. New structural elements, e.g., new horizon surfaces, seismic interpretation points or well tops, etc., may then be extracted from the updated implicit function (block 534). For example, in some embodiments, the average or representative value computed in block 526 may be extracted as a surface using an iso-surfacing algorithm, or as a set of new well tops by locating the corresponding iso-values on one or several well traces.

It will be appreciated that the techniques disclosed herein may be used in other applications to correlate other types of subsurface formation data, and therefore the invention is not limited to the particular applications disclosed herein. In addition, while particular embodiments have been described, it is not intended that the invention be limited thereto, as it is intended that the invention be as broad in scope as the art will allow and that the specification be read likewise. It will therefore be appreciated by those skilled in the art that yet other modifications could be made without deviating from its spirit and scope as claimed.

What is claimed is:

1. A method of generating structural information for a subsurface formation, comprising:
determining a location in a volume of interest in the subsurface formation from subsurface formation data associated with the subsurface formation;
accessing a numerical model having a monotonously varying stratigraphic implicit function defined within the volume of interest to determine a value of the stratigraphic implicit function corresponding to the determined location; and
generating at least one structural element for the subsurface formation from the stratigraphic implicit function of the numerical model based upon a spatial distribution of the determined value within the volume of interest.

2. The method of claim 1, further comprising:
receiving user input directed to a graphical depiction of subsurface formation data, wherein determining the location in the volume of interest includes determining the location based upon the user input; and
causing a graphical depiction of the at least one structural element to be displayed in the graphical depiction of the subsurface formation data.

3. The method of claim 2, wherein:
the graphical depiction of subsurface formation data comprises a graphical depiction of subsurface formation data for each of first and second boreholes formed in the subsurface formation;
the user input comprises user selection of a first proposed well top for the first borehole on the graphical depiction of subsurface formation data for the first borehole;
the location in the volume of interest includes a depth along the first wellbore corresponding to the user selection of the first proposed well top;
accessing the numerical model to determine the value of the stratigraphic implicit function comprises determining the value of the stratigraphic implicit function at the depth along the first borehole;
generating at least one structural element comprises generating, for the second borehole, a second proposed well top corresponding to the first proposed well top for the first borehole based upon the determined value of the stratigraphic implicit function; and
causing the at least one structural element to be displayed in the graphical depiction of the subsurface formation data includes causing a graphical depiction of the second proposed well top to be displayed on the graphical depiction of subsurface formation data for the second borehole.

4. The method of claim 3, wherein the graphical depictions of subsurface formation data for the first and second boreholes each comprise a well track of a well log or a well path in a three dimensional view.

5. The method of any of the preceding claims, wherein:
the subsurface formation data includes subsurface formation data for each of first and second boreholes formed in the subsurface formation;
the location in the volume of interest includes a depth along the first wellbore corresponding a first proposed well top for the first borehole;
accessing the numerical model to determine the value of the stratigraphic implicit function comprises determining the value of the stratigraphic implicit function at the depth along the first borehole; and
generating at least one structural element comprises generating, for the second borehole, a second proposed well top corresponding to the first proposed well top for the first borehole based upon the determined value of the stratigraphic implicit function.

6. The method of claim 5, further comprising sampling the stratigraphic implicit function along each of first and second well paths respectively corresponding to the first and second boreholes, wherein accessing the numerical model to determine the value of the stratigraphic implicit function includes determining the value from the sampled stratigraphic implicit function along the first well path, and wherein generating the second proposed well top comprises generating a location of the second proposed well top from the sampled stratigraphic implicit function along the second well path.

7. The method of claim 6, wherein sampling comprises sampling at substantially regular depths along the first and second well paths or sampling at intersections between the first and second well paths and faces of a tetrahedral mesh of the numerical model.

8. The method of claim 6, wherein sampling further comprises taking at least one sample proximate an intersection between the first or second well path and a discontinuity, a fault or a conformable horizon defined in the numerical model.

9. The method of claim 5, further comprising, after generating the second proposed well top based upon the determined value of the stratigraphic implicit function, automatically adjusting a location of the second proposed well top based upon first and second petrophysical logs respectively associated with the first and second boreholes, and wherein automatically adjusting the location of the second proposed well top includes iteratively perturbing an offset or a stretch/squeeze factor and correlating the first and second petrophysical logs in a vicinity of the first and second proposed well tops.

10. The method of any of the preceding claims, wherein the at least one structural element comprises a geological map of an intermediate geological horizon, and wherein the intermediate geological horizon is not used to constrain the numerical model prior to being generated.

11. The method of any of the preceding claims, wherein:
the subsurface formation data comprises a seismic image;
the location in the volume of interest corresponds to a point in the seismic image;
accessing the numerical model to determine the value of the stratigraphic implicit function comprises determining the value of the stratigraphic implicit function at the point in the seismic image; and
generating at least one structural element comprises generating a surface or a plurality of points in the seismic image based upon the determined value of the stratigraphic implicit function.

12. The method of any of the preceding claims, wherein:
determining the location in the volume of interest includes determining a plurality of locations in the volume of interest;
accessing the numerical model to determine the value of the stratigraphic implicit function comprises:
determining the value of the stratigraphic implicit function for each of the determined plurality of locations; and
determining a residual for each of the determined plurality of locations from the determined value for each of the plurality of locations; and
generating at least one structural element comprises generating a surface or a plurality of points based upon the determined value and determined residual for each of the plurality of locations.

13. The method of claim 12, wherein the residual is interpolated, wherein determining the residual for each of the plurality of locations includes determining the residual at a first location among the plurality of locations as a difference between the value of the stratigraphic implicit function for the first location and an arbitrarily selected value, and wherein the method further comprises updating the stratigraphic implicit function by adding the determined residual for each of the plurality of locations with the determined value for the stratigraphic implicit function for each of the plurality of locations.

14. An apparatus, comprising:
at least one processing unit; and
program code configured upon execution by the at least one processing unit to generate structural information for a subsurface formation using the method of any of claims 1-13.

15. A program product, comprising:
a computer readable medium; and
program code stored on the computer readable medium and configured upon execution by at least one processing unit to generate structural information for a subsurface formation using the method of any of claims 1-13.
